(19) United States
(12) Patent Application Publication
(10) Pub. No.: US 2025/0022082 A1
(43) Pub. Date: Jan. 16, 2025

(54) DATA AND CONTRACT SYSTEMS AND METHODS USING MICRO-LEDGERS

(71) Applicant: Portable Data Corp, Oakland, CA (US)

(72) Inventors: James Fournier, Nicasio, CA (US); Victor Grey, Concord, CA (US); Jared Grippe, Camptownville, CA (US)

(21) Appl. No.: 18/769,965

(22) Filed: Jul. 11, 2024

Related U.S. Application Data
(60) Provisional application No. 63/513,300, filed on Jul. 12, 2023.

(51) Int. Cl. G06Q 50/18; H04L 9/00

(52) U.S. Cl. CPC G06Q 50/18; H04L 9/50

(57) ABSTRACT

Disclosed are data contract systems and methods using micro-ledgers. One or more computer processors are configured to: in response to receiving input from a first party, configure a first software agent with one or more revocable permissions to act on behalf of the first party, the one or more revocable permissions including signing a contract between the first party and a second party; in response to receiving input from the second party, configure a second software agent with one or more revocable permissions to act on behalf of the second party, the one or more revocable permissions including signing the contract; and record one or more events using the first and second software agents, each acting within its respective revocable permissions, to one or more micro-ledgers. The one or more events either form or evidence the contract, which is human readable, machine readable, and legally enforceable.

### CROSS REFERENCE TO RELATED APPLICATIONS

This document claims the benefit of the filing date of U.S. Provisional Patent Application No. 63/513,300, entitled “Data and Contract Systems and Methods using Micro-ledgers,” naming as first inventor James Fournier, which was filed on Jul. 12, 2023, the disclosure of which is hereby incorporated entirely herein by reference.

### BACKGROUND

### 1. Technical Field

Aspects of this document relate generally to blockchains, contracts, smart contracts, and micro-ledgers.

### 2. Background Art

A blockchain is a list of records or “blocks” cryptographically linked together using cryptography, each block including a cryptographic hash of the previous block, a timestamp, and transaction data. A contract is a legally enforceable agreement that creates, defines, and governs mutual rights and obligations among parties. A smart contract is a computer program or transaction protocol intended to automatically execute, control or document legally relevant events and actions according to terms of a contract or agreement. A smart contract may for example be a collection of code and data deployed using cryptographically signed transactions on a blockchain. Some examples of micro-ledgers exist, for example a log containing the history of one key-like a blockchain with only one participant.

### SUMMARY

In some aspects, the techniques described herein relate to data contract methods using micro-ledgers, including: using one or more computer processors: recording to one or more micro-ledgers, using a first software agent having one or more permissions to act on behalf of a first party, one or more events, wherein the one or more permissions of the first software agent include permission to sign a contract on behalf of the first party; recording to the one or more micro-ledgers, using a second software agent granted one or more permissions to act on behalf of a second party, one or more events, wherein the one or more permissions of the second software agent include permission to sign the contract on behalf of the second party; wherein the one or more events recorded using the first software agent and the one or more events recorded using the second software agent one of include and evidence the contract between the first party and the second party; wherein the contract is human readable, machine readable, and legally enforceable.

In some aspects, the techniques described herein relate to a data contract method using micro-ledgers, including: using one or more computer processors: in response to receiving input from a first party through one or more computing devices, configuring a first software agent with one or more revocable permissions to act on behalf of the first party, the one or more revocable permissions including signing a contract between the first party and a second party; in response to receiving input from the second party through the one or more computing devices, configuring a second software agent with one or more revocable permissions to act on behalf of the second party, the one or more revocable permissions including signing the contract; and recording one or more events using the first software agent and the second software agent, each acting within its one or more revocable permissions, to one or more micro-ledgers; wherein the one or more events one of include and evidence the contract; and wherein the contract is human readable, machine readable, and legally enforceable.

In some aspects, the techniques described herein relate to a method, wherein the input from the first party includes a cryptographically signed document, and wherein the input from the second party includes a cryptographically signed document.

In some aspects, the techniques described herein relate to a method, further including, in response to receiving input from the first party through the one or more computing devices, revoking one or more or all permissions of the first software agent to act on behalf of the first party.

In some aspects, the techniques described herein relate to a method, further including configuring a third software agent with one or more revocable permissions to act on behalf of the first party.

In some aspects, the techniques described herein relate to a method, wherein the method does not require the use of blockchain consensus because formation of the contract, data exchange, and data control occur off-chain, and wherein the method further does not require a consensus fee, does not require the use of a data exchange fee, and does not require the use of a crypto wallet.

In some aspects, the techniques described herein relate to a method, wherein the methods are implemented at least in part using a data-exchange control layer for decentralized applications (dApps).

In some aspects, the techniques described herein relate to a method, wherein the methods are configured to operate outside of a Web3 computing environment.

In some aspects, the techniques described herein relate to a method, wherein the first software agent and the second software agent write to the one or more micro-ledgers using their own unique decentralized identifiers (DIDs), and wherein the DIDs are used to define ownership and access control over the one or more micro-ledgers.

In some aspects, the techniques described herein relate to a method, wherein one or more DID documents are further used to define ownership and access control over the one or more micro-ledgers.

In some aspects, the techniques described herein relate to a method, wherein the one or more micro-ledgers do not require any token, do not require centralization, and do not require authority to be created or shared.

In some aspects, the techniques described herein relate to a data contract system using micro-ledgers, including: one or more servers at least intermittently communicatively coupled with one or more computing devices and providing one or more software elements, the one or more software elements configured to be executed by one or more processors to; in response to receiving input from a first party through the one or more computing devices, configure a first software agent with one or more revocable permissions to act on behalf of the first party, the one or more revocable permissions including signing a contract between the first party and a second party; in response to receiving input from the second party through the one or more computing devices, configure a second software agent with one or more revocable permissions to act on behalf of the second party, the one or more revocable permissions including signing the contract; record one or more events using the first software agent and the second software agent, each acting within its one or more revocable permissions, to one or more micro-ledgers; and wherein the one or more events one of include and evidence the contract; and wherein the contract is human readable, machine readable, and legally enforceable.

In some aspects, the techniques described herein relate to a system, wherein the first software agent and the second software agent write to the one or more micro-ledgers using their own unique decentralized identifiers (DIDs).

In some aspects, the techniques described herein relate to a system, wherein the one or more events are recorded using a directed acyclic graph (DAG) data structure.

In some aspects, the techniques described herein relate to a system, wherein the one or more software elements are configured to record the one or more events regardless of which specific DAG data structure is used.

In some aspects, the techniques described herein relate to a system, wherein the contract facilitates an automated data exchange between data stores and governs use of the exchanged data.

In some aspects, the techniques described herein relate to a system, wherein one of the first software agent and the second software agent includes software code running in a cloud computing environment.

In some aspects, the techniques described herein relate to a system, wherein one of the first software agent and the second software agent is substantially always online in a networked computing environment.

In some aspects, the techniques described herein relate to a system, wherein the one or more events recorded by the first software agent and the one or more events recorded by the second software agent are immutable, non-repudiable, and auditable.

In some aspects, the techniques described herein relate to a system, wherein the one or more software elements are further configured to write to one or more documents using the first software agent or the second software agent, and wherein the one or more documents one of include and evidence the contract.

General details of the above-described implementations, and other implementations, are given below in the DESCRIPTION, the DRAWINGS, the CLAIMS and the ABSTRACT.

### BRIEF DESCRIPTION OF THE DRAWINGS

Implementations will be discussed hereafter using reference to the included drawings, briefly described below, wherein like designations refer to like elements. The drawings are not necessarily drawn to scale.

FIG. 1 representatively illustrates an example of a computing environment that may be used in the systems to implement the data and contract systems and methods using micro-ledgers;

FIG. 2 illustrates a representative example of a data and contract system using micro-ledgers; and

FIG. 3 is a block diagram representatively illustrating data and contract methods using micro-ledgers.

### DESCRIPTION

Implementations/embodiments disclosed herein (including those not expressly discussed in detail) are not limited to the particular components or procedures described herein. Additional or alternative components, assembly procedures, and/or methods of use consistent with the intended test case may be utilized in any implementation. This may include any materials, components, sub-components, methods, sub-methods, steps, and so forth.

The methods and systems disclosed herein can be implemented using a variety of computing environments and devices, including personal computers, server computers, mobile devices, smart speakers, data stores, database servers, databases, web servers, smart watches, smart glasses, tablets, laptops, a telecommunications network (such as the Internet), etc. Before describing the embodiments in detail, a discussion of example computing environments in which the embodiments can be implemented may be useful.

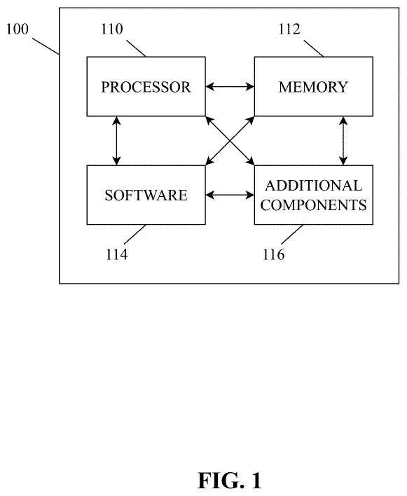

FIG. 1 depicts a high-level block diagram of a general-purpose computing device suitable for use in performing some of the functions described herein. As depicted in FIG. 1, the computing device 100 includes a processor 110 (e.g. a CPU); memory 112, e.g. random-access memory (RAM) and/or read-only memory (ROM); software 114 for implementing the methods (or portions of the methods) described herein; and various additional components 116 which may be implemented as hardware and/or software (such as, by non-limiting example, a receiver and transmitter for communicating with other computing devices of the system locally and/or through a telecommunications network, wireless communication elements, one or more microphones and/or speakers for audio input/output, one or more displays for presenting information in visual format and/or for user interfaces, a text-to-speech synthesizer for converting text to speech, a speech-to-text converter, user input elements such as a keyboard, keypad, touchscreen, mouse, and so forth). The double-arrowed connectors of FIG. 1 representatively illustrate the individual elements being able to communicate with one another.

It should be noted that portions of the systems and methods can be implemented using software and/or a combination of software and hardware, e.g. using application specific integrated circuits (ASIC), general purpose computers, or any other hardware equivalents. In one embodiment, the methods may be implemented using software 114, the software loaded into memory 112 and executed by processor 110 to implement the functions discussed herein. As such, in implementations the methods disclosed herein may be implemented using one or more non-transitory computer-readable storage media, e.g., one or more RAM memories, one or more magnetic or optical drives or diskettes, and/or so forth.

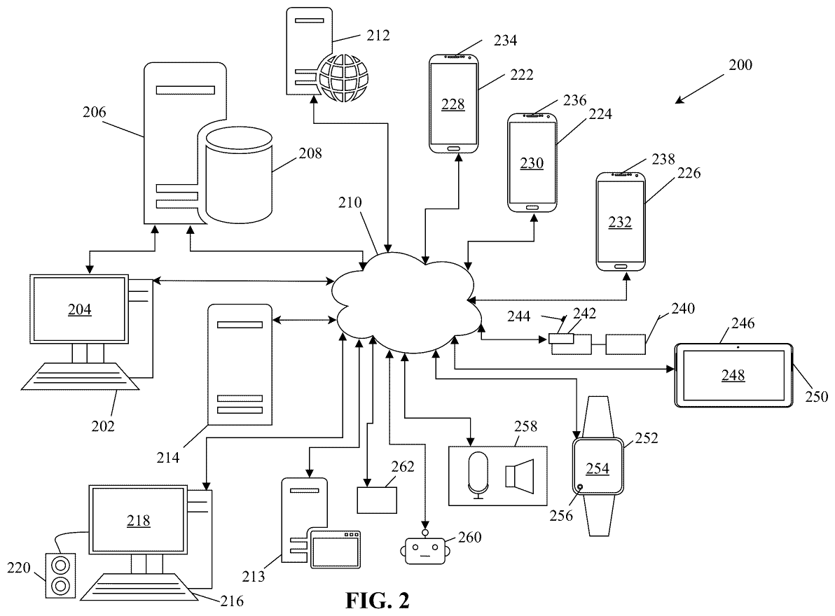

Referring now to FIG. 2, an example of a data and contract system 200 using micro-ledgers is shown. The system includes a plurality of computing devices, each of which may include some or all of the elements described previously with respect to FIG. 1.

For example, computing device 202 includes interface 204 and is an administrator device. This device may be used by an administrator (admin) to populate a data store (such as database 208, using database server 206), with some of the elements of the system(s), and to make changes to the database elements. In implementations data stores other than databases may be used. As used herein, a database is considered a subset of a data store. In the implementation shown the admin device is coupled with the DB server directly, though also through a telecommunications network 210 which may be, by non-limiting example, the Internet, though it could also be a local area network (LAN) in a more localized deployment of the system. The admin device could also communicatively couple with the database/DB server through a web server 212, such as by accessing a website using credentials. The admin device is shown as a desktop computer but could be a laptop, mobile phone, tablet, smart watch, smart speaker, smart glasses, and so forth.

In implementations the admin computer, DB server, database, web server, and the like could all be implemented on a single machine (such as using virtual servers on a single machine) but in large network deployments there will more likely be a plurality of cloud-connected server racks used to implement these various elements as the number of users scales up. For example, AMAZON WEB SERVICES (AWS) server racks may be utilized to implement the database server, the database, the web server, and so forth so that the number of users may be increased to very large numbers.

The admin and/or users could access elements of the system through one or more software applications on a computer, smart phone, tablet, or any other computing device, such as through one or more software applications (such as by non-limiting example a mobile app having interactive user interfaces) facilitated at least in part by one or more application servers 213.

In implementations the system may interact with third party servers 214 (which may include databases) to gather and/or store/retrieve information and/or to at least partially perform one or more of the functions disclosed herein. This may allow the methods and/or functions disclosed herein to be at least partially delegated and/or performed by third parties using their own servers and/or hardware/software. As a non-limiting example, the systems disclosed herein may communicate with servers associated with FACEBOOK or GOOGLE to access user login credentials or to otherwise facilitate user logins using FACEBOOK and/or GOOGLE credentials. This is only one representative example, and third party server(s)/database(s) may be used for a variety of other purposes.

FIG. 2 shows system 200 having a number of user devices simultaneously communicatively coupled with the database 208 via the telecommunications network, including a personal computer 216 (which could be a desktop or laptop or other type of computer, for example) having a display 218 and an associated microphone/speaker 220, a number of mobile phones 222, 224, 226 each having a respective display 228, 230, 232 and respective microphone/speaker elements 234, 236, 238, smart glasses 240 including a display 242 and microphone/speaker elements 244 (a representative example of this would be GOOGLE GLASS), a mobile tablet 246 including display 248 and microphone/speaker elements 250, a smart watch 252 including a display 254 and microphone/speaker elements 256, a smart speaker 258 including microphone/speaker elements (representative examples would be GOOGLE HOME, AMAZON ECHO, APPLE HOMEPOD, and the like), a robot 260 (which may be a humanoid robot, a social robot, a talking head, an avatar, an embodied virtual agent, an embodied avatar, or any other robot type and which may include microphone/speaker elements for user interaction), and any other human interaction device 262 which may include microphone/speaker and/or visual input/output and/or other input/output elements for user interaction (by non-limiting example, user interfaces integrated in automobiles, trucks, buses, airplanes, telephones, interactive advertising displays, street furniture, Internet of Things devices, wearable technology, virtual receptionist kiosks, and any other human interaction device now known or hereafter discovered/invented).

The system(s) at any given moment may have fewer or more user devices communicatively coupled with it, and each type of device may be scaled up to any number of users—FIG. 2 is accordingly a simplified diagram. For example, in implementations there may be thousands of users, or more, simultaneously interacting with the system(s), and the system(s) and methods disclosed herein may interact with third party software/elements on the user devices (which may involve their own accessing of remote servers and databases and the like). For example, GOOGLE ASSISTANT, AMAZON's ALEXA, or APPLE's SIRI may interact with the system(s) to help facilitate the functions disclosed herein. The system(s) may also have other elements for implementing the methods.

While various embodiments of the systems and methods have been described above at a high level, these have been presented by way of example only, and not by way of limitation. Thus, the breadth and scope of a preferred embodiment of any system or method disclosed herein should not be limited by any of the above-described exemplary embodiments.

Web3 is a yet-to-be-well-defined term for a collection of technologies that use cryptographic keys and hashes combined with distributed ledgers to achieve decentralized consensus and cross-app cooperation on the internet. In practice, this has largely meant monetized activity on blockchains. This has created a new financial capital market on the internet. However, the consensus methods necessary for ensuring secure financial transactions are inherently too slow and expensive (computationally, financially, and often environmentally) for the everyday high-speed data exchange needed for the decentralized web.

There are a number of possible meanings of “decentralized.” For blockchain, it means a set of separate nodes all running the same protocol to create a single “source of truth,” e.g., the ledger. For decentralized applications (dApps) and web3 the term decentralized is also often conflated with a consensus algorithm, the process by which “individual action” is turned into a “shared state.” However, turning decentralized action into a centralized state using a consensus algorithm introduces a bottleneck.

Cryptocurrencies must form consensus from a constellation of disparately owned-and-operated, untrusted nodes each complying with a protocol before appending to a global ledger that produces a single centralized source of truth. That ledger is gated by a monetary consensus algorithm (and often monetary fees). To ensure that no one actor can manipulate the ledger, a complex process of consensus (mining, staking, etc.) must be completed before a transaction can be complete. This results in a slow and costly infrastructure. For Web3 to scale for data the ledger itself needs to be decentralized.

The architecture of a decentralized network should support the needs of the parties in that network. Virtually none of the parties on the internet are running servers that create nodes on blockchains, in fact very few are running servers of any kind. Most are using services, where they have a client application that is dependent on the terms dictated by those services. This is increasingly true even for developers and enterprises. The network is made up of cloud services where the activity is all at the application programming interface (API) level between those virtual servers. The existence of blockchains is largely orthogonal to the data flows and agreements between parties which are all happening off-chain using proprietary APIs.

For the most part non-monetary data, permission, and metadata has been outside the scope of Web3. And yet the existence of ubiquitous cryptographic key technology such as public key infrastructure (PKI), irreversible hashes, and World Wide Web Consortium (W3C) standards such as decentralized identifiers (DIDs) and verifiable credentials (VCs), all combined with directed acyclic graph (DAG) technology, which could also be described as “tokenless” distributed ledger technologies (DLTs), make it possible to create a protocol for off-chain data exchange control.

Sharing data between dApps is useful for and/or may facilitate the Web3 revolution. As more and more apps have access to data about a user, having a layer that defines how that data is allowed to be used is useful. Allowing the user to define his/her own your terms, view the counter-party's terms, and sign compatible data sharing agreements automatically will significantly increase the security of the distributed web.

While a blockchain may sound like a good place to store these agreements, there are better options. DAGs provide the same reliability and verifiability of a blockchain but without the overhead delay or cost of consensus fees.

The data and contract systems and methods using micro-ledgers (hereinafter referred to at times as “JLINX”) disclosed herein offer a new approach to Web3 using tokenless micro-ledgers, combined with serialized data in JavaScript Object Notation (JSON), to give both individuals and organizations control over data sharing and decision making. Each party controls its own agent node which writes to its own micro-ledger(s). Human and machine-readable contracts provide data control, legal agreements and governance using decentralized identifiers (DIDs) and verifiable credentials (VCs), with non-repudiation, written to micro-ledgers and optionally to other blockchains. JLINX decentralizes both the ledger and consensus mechanism. Each “actor” or party interacting with the system(s) may be represented using a unique decentralized identifier (DID). Every DID may be tied to cryptographic key pairs used to sign any actions taken by that actor. This gives individuals, organizations, and software applications persistent self-sovereign identity online. Additional identities (DID-based identifiers) can be created at-will where “persistent pseudonymous identity” with specific parties is required. For example a user (or its agent) can create a new DID for each website the user signs up with to ensure those apps cannot cross correlate the activity and data for that user.

In implementations the systems and methods provides the basis for a functional multi-party implementation of verifiable credentials where each party maintains its own DID controlled by its own agent and anchored on its own micro-ledger, which has significant privacy advantages and scales better than verifiable credentials on a cryptocurrency.

In implementations JLINX is an automated data agreement layer for the distributed web. A JLINX Agent may be an online actor that can be granted revocable rights to act on behalf of a specific party. Individuals and organizations may be represented by their own agents as nodes in the network that can sign and hold data agreements with other parties and prove the validity of the data agreements that they hold, without requiring consensus on any global ledger. JLINX agents can record immutable events on any directed acyclic graph (DAG) data structure such as Ceramic, Hypercore or Holochain to reference data, identity and agreements in a fast, truly decentralized network without gas fees, and can also write any event or roll-up to any other ledger or blockchain.

The methods disclosed herein may be facilitated by software running on one or more of the aforementioned computing devices and having instructions to execute the disclosed method steps. JLINX “agents” may be implemented using software on any of the aforementioned computing devices and may be configured to record immutable events on any micro-ledger (which as used herein refers to a directed acyclic graph (DAG) data structure such as by non-limiting example Ceramic, Hypercore or Holochain) to reference data, identity and agreements in a fast, decentralized network without overhead cost for gas fees on consensus blockchains. The micro-ledgers may be stored on one or more of the aforementioned computing devices and/or servers.

JLINX systems and methods may in implementations use or include a decentralized off-chain data agreement protocol, which may be implemented using software or instructions on one or more of the aforementioned computing devices. This gives both individuals and organizations control over data sharing and decision making. Each party may be represented by its own software-implemented agent node. Human and machine-readable contracts generated by the data and contract systems and methods provide data control, legal agreements, and governance.

Using the system(s) and methods described herein, each party to a contract may be represented by its own agent that can manage its signed agreements and hold keys to sign those agreements based on signed instructions from the party represented by that agent. In implementations an agent node is code that runs in the cloud and that can be granted permission to take actions on behalf of another entity. Each agent node may have its own identifier (DID) and may be given explicit rights to act on behalf of another identifier. These rights may be represented as verifiable claims that are immutably written to a micro-ledger and that can only be revoked via explicit action by the controlling entity.

In implementations agent nodes may be always online to manage data sharing agreements. This may include using a private server or a trusted software as a service (SaaS) provider to represent each party online. This allows data to be always available to other nodes in the network. Agents may verify and react to incoming events and requests from other nodes. Like smart contracts, agent nodes can be instructed to take actions (execute code) in reaction to other events on the network. Unlike smart contracts, code is solely executed by an agent representing one of the parties, and results in writing new events on micro ledgers that are owned and operated on behalf of that party.

The systems and methods disclosed herein lay the foundation for an automated and decentralized basis for trust. The data agreement layer gives everyone greater control over the data they share online, giving each party agency in a system based on symmetrical permissioned data exchange. The network architecture maps decentralization to the social, legal, and commercial structure of society, where each party not only has self-sovereign identity, but self-sovereign agency.

In implementations the agent may be implemented using software as a service (JLINX Agent as a Service or JAaaS). JAaaS directly addresses the “nobody wants to (or should have to) run their own server” problem articulated by Moxie Marlinspike in his influential post, “My First Impressions of Web3.” JLINX Agents as a service may be hosted and managed by third parties. While users would need to trust one of those third parties to not steal their data, the JLINX Protocols allow the root identity owner to revoke rights granted to keys held by any agent. The root identity keys may be listed as “Owner and controller” and the agent's keys may be listed as “Agent Controller” on any documents or event streams that the owner grants the agent control over.

In implementations any root identity may grant rights to a hosted JLINX Agent service and later revoke those rights and move those responsibilities to another agent. This allows the development of desktop applications (apps), mobile apps, and browser extensions that can hold and use subordinate identity keys to interact to multiple JLINX agents in the cloud under the control of a client app that holds the root keys on a local device. Applications on the local devices can use whatever combination of biometric, pin, password, or other second/multi factor authentication as is desired. Desktop and mobile apps can take advantage of any PKI storage technology such as APPLE′S KeyChain, FIDO, RSA hardware, etc.

A hardware key could be used to initially establish a DID and then grant revocable access to DIDs that represent the local apps and online agents, so that no matter how many other devices are compromised the user has a path to restore full control over their online identity.

Authentication between a hosted JLINX Agent and the user (or his/her local apps) can be implemented using any existing web authentication technology. Hosted agents can also provide data recovery and key recovery.

JLINX systems and methods may in implementations be based on a JLINC Protocol for data control combined with tokenless micro-ledgers built on Ceramic, Hypercore, or other DAG-based distributed databases. The JLINC Protocol provides a way to assemble methods, systems and techniques to provide confidentiality and to represent fiduciary relationships and accountability for parties sharing data over the Internet. It facilitates control over shared data, provenance of that data, non-repudiation of data-sharing actions using standard public/private key cryptography (PKI), JSON linked data (JSON-LD), decentralized identifiers (DIDs), and verifiable credentials (VCs).

JLINX agent nodes represent each party. In implementations the agents are configured to act on a party's behalf, including by signing contracts which contain human readable text, pointers to text, and context necessary to automate exchange between data stores. As indicated previously, FIG. 2 is a simplified diagram (and even then some data and contract systems may exclude many of the elements therein)—but in implementations each party to a contract may have its own data store communicatively coupled with one or more of the computing devices. Agents are in implementations configured to be granted rights by the parties and use their own decentralized identifiers (DIDs) to write to their own event stream and documents (e.g. Ceramic Tile or Hypercore), to provide non-repudiation and auditable records. Agents can also optionally record events and documents to any combination of other ledgers and blockchains, as instructed or set up by a party/user.

Under Web 2 a user gives its data to some website owner/operator, who stores it in its database(s), and the user hopes the data will not be used contrary to his/her will. With JLINX systems and methods the user controls its own data, who can see it, what they can do with it, if they're allowed to keep a copy, and so forth. Everything (every event/action related to the data) is logged on immutable ledgers without gas fees.

In implementations the JLINX systems and methods may be implemented in part or in whole as a data-exchange control layer, for Web3 decentralized applications (dApps), that doesn't require a user to have a crypto wallet or to pay data-exchange fees.

In implementations, businesses that want access to user data run their own JLINX agent nodes on their own computing devices. The user or its agent can grant those nodes tightly defined access to the user's data. The systems and methods may in implementations facilitate the business paying the user for the data.

In implementations the JLINX systems and methods offer a simple, elegant, cryptographically secure way of signing and exchanging human-readable agreements governing data used across any combination of websites, databases, applications and codebases.

### JLINX Micro-Ledgers

For decentralized application (dApp) interoperability and data provenance, “micro-ledgers” are like individual blockchains where only the owner/key holder(s) can write to their unique ledger address. This provides free, tokenless, immutable, non-monetary data stores where each party writes to its own ledger stream.

Micro-ledgers used by the systems and methods disclosed herein are single-author topical event streams (tiny blockchain). The systems are configured such that each actor (whether human or code), can create a micro-ledger simply by generating a cryptographic signing key pair, and then writing a series of events (blocks) that are cryptographically signed to ensure order. The public key is considered the identification (ID) of the micro-ledger. Two or more actors can use the systems and methods to create pairs of event streams to form bi-directional relationships with each other. The systems and methods may utilize encryption to facilitate private relationships. DIDs and DID Documents are used to define ownership and access control over the micro-ledgers.

### Micro-Ledger Protocols

JLINX systems and methods are in implementations based on a set of distributed protocols for establishing and exchanging self-sovereign identity, agreements, permissions, roles and governance. The systems and methods may in implementations use human and machine readable append-only documents. JLINX Documents (Identity, Profile, Contract, etc.) may all be implemented using immutable event streams that serve as an immutable audit trail. A hash of the state of any document can be written to any blockchain stored on any device(s)/server(s)/memory (ies) of the system(s) to enable data exchange with smart contracts. This allows governance to happen at high-speed (off-chain) but to also interoperate with on-chain smart contracts providing legal documentation and governance for Web3.

In implementations JLINX micro-ledgers may be implemented using the Ceramic protocol where streams called Tiles are used to represent and manage immutable multi-party states. An initial JLINX demo was built on Hypercore.

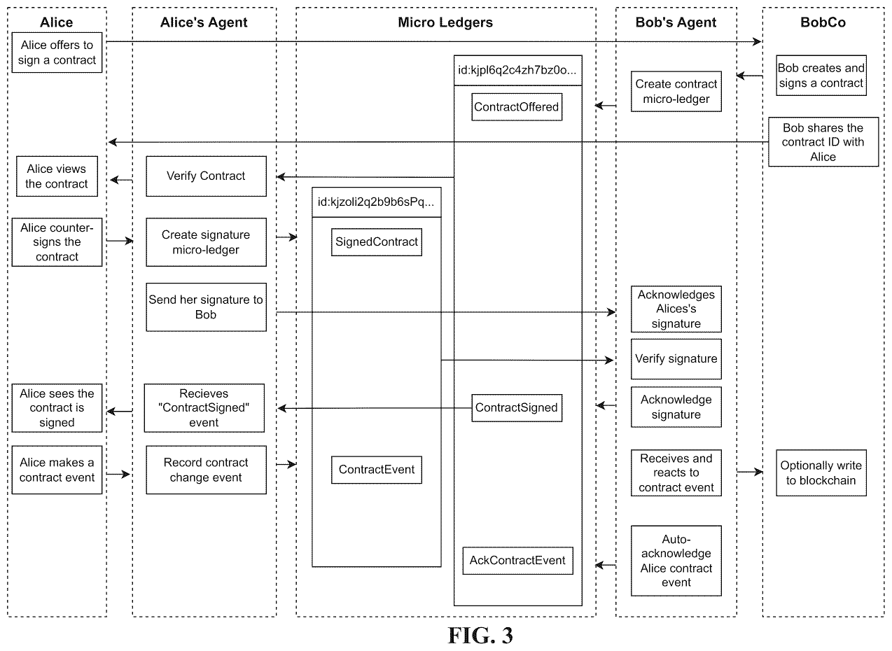

FIG. 3 is a block diagram representatively illustrating data and contract methods using micro-ledgers, and may also be called a contract flow diagram.

The following example steps refer to the example contract flow diagram of FIG. 3:
Alice wants to sign a contract with Bob.
Bob creates and signs a contract offering using his DID.
Bob's Agent creates a new micro-ledger for his contract events.
The first event is an event offering that either includes a link to contract details or includes the contract details directly.
Alice's Agent verifies the contract offering is from Bob.
Alice signs the contract.
Alice's Agent creates a new micro-ledger for her contract events.
Bob's Agent receives the signature, verifies it, and writes an acknowledgement event to Bob's ledger.
Alice's Agent sees the signature acknowledged event.
Alice now sees the contract as signed using her signature.
Alice's Agent and Bob's Agent can now communicate about this contract automatically by appended events to their personal ledgers.
Alice then takes some action under the details of the contract.
Alice's agent records a “contract event” to her micro-ledger.
Bob's agent receives the data change event from Alice's ledger.
Bob's Agent can take any programmable actions needed in response to Alice's event including writing a universally unique reference to this event to any blockchain.

In implementations the systems and methods may join, order, and project events of multiple micro-ledgers, using shared open source software, to create shared states.

Protocols implemented by the systems and methods may allow applications (such as applications implemented by the systems and/or independent applications not implemented by the systems) to share user identity information, relationship information (e.g., memberships, roles, permissions), content (e.g., white hot memes) and more between contract parties.

In implementations JLINX actors (whether parties or agents) do not communicate directly, but instead they each emit events on many event streams which one or more other actors listen to. Other actors can react to an event by emitting their own event on a stream that the originating party (or its agent) listens to. The data streams may be facilitated by the computing elements and/or servers of the systems.

Because micro-ledger streams do not themselves require any token or centralization of any kind, they require no authority to be created and shared, and cost only the resources needed to create and share a file.

In implementations some JLINX protocols allow actors to enable other actors to act on their behalf. This is done by generating a cryptographically signed document granting revocable rights to party B to do X, Y or Z on behalf or party A. This mechanism allows JLINX agents to take actions on behalf of an actor.

For non-monetary data exchange (e.g., identities, agreements, claims, etc.) the system may utilize multiple interacting Ceramic tiles (tokenless append-only micro-ledgers), effectively braiding them together to form eventual consensus.

When a user needs data tied to a specific blockchain, JLINX can be thought of as a layer 2 (L2) roll-up, publishing batches of references to JLINX ledgers (or specific JLINX ledger entries).

The systems and methods disclosed herein (and also called JLINX systems and methods) may accordingly use standard cryptography, JSON documents, human-readable contracts, and distributed ledgers based on directed acyclic graph technology to build reliable and verifiable claims of relationship, permission, and roles, which are independent of transport and do not require consensus on a blockchain.

In implementations the contracts generated and managed by the system(s) (the contract also called “JLINX contracts” herein) are different from smart contracts in two ways: they are actual legal contracts, not computer code (i.e., they can include human-readable text, of actual legally binding contracts, which specify the intent of the parties in the event of any unexpected behavior by the code); and as such they can ultimately be adjudicated by a judge under the legal system rather than by a compiler.

JLINX contracts accordingly may be human and machine-readable agreements expressed in JSON and signed with cryptographic keys using standard PKI. This allows human readable agreements that dictate how data can be used or shared and that facilitate the automatic and transparent handling of such date use/sharing. The expected outcome of the agreement remains apparent to anyone, including a human judge. The parties of the agreement are identified using DIDs and their signatures may in implementations be executed with standard cryptographic keys using standard PKI. Other signature/execution methods may be used in implementations, though the use of standard cryptographic keys using standard PKI has understandable advantages.

Any person or any organization of any kind can use the system(s) and methods to enter into secure, irrefutable agreements, able to be legally adjudicated, governing the exchange and use of data shared under that agreement. As non-limiting examples, data sharing agreements can be used to stipulate terms such as: how long a user can store the data; in what ways the data can be used; under what conditions the data can be used or no longer used; under what conditions (time or otherwise) the data should be purged; requirements to log and report all usage or sharing of the data; and requirements to be financially compensated for specific usages of the data.

In implementations the agreements are created, exchanged, and persisted in systems independent of the mechanism used to provide verification and proof of the contract/agreement. This means either party can store copies of the agreement anywhere and in any way they like, and it can still be verifiable by a third party. While agreements might stipulate financial compensation, the agreements and verification of those agreements may be independent of any specific system. JLINX Agents and agreements may thrive on Web3 but in implementations they do not depend on it. JLINX Agents and agreements may be independent of persistence and data exchange layers. JLINX Agents could be implemented on a carrier pigeon network.

Details of specific example implementations of data and contract systems and methods using micro-ledgers are disclosed in the following Appendices to the specification:

APPENDIX D: additional example details, descriptions, and software code-related elements relevant to PC computing devices;

APPENDIX E: additional example details, descriptions, and software code-related elements relevant to MAC OS computing devices;

APPENDIX F: additional example details, descriptions and definitions related to data and contract systems and methods; and

APPENDIX G: “ChronStamp White Paper” dated Oct. 11, 2022, including all drawings and figures therein.

In implementations the systems and methods herein may further include and/or be modified using any details disclosed in any of the following (and, additionally, any of the terms and phrases herein may in implementations be defined as they are defined in any of the following), each of which is incorporated entirely herein by reference (along with any references in turn incorporated by reference in those respective documents): U.S. Pat. Pub. No. 2016/0300223 A1, published Oct. 13, 2016, listing as first inventor Victor Grey, titled “Protected Data Transfer Across Disparate Networks;” U.S. Pat. Pub. No. 2021/0166246 A1, published Jun. 3, 2021, listing as first inventor James Fournier, titled “Internet Data Usage Control System;” U.S. Pat. No. 11,556,959, issued Jan. 17, 2023, listing as first inventor James Fournier, titled “Internet Data Usage Control System;” U.S. Pat. Pub. No. 2023/0095123 A1, published Mar. 30, 2023, listing as first inventor James Fournier, titled “Systems and Methods for Digitally Signed Contracts with Verifiable Credentials;” U.S. patent application Ser. No. 18/344,359, filed Jun. 29, 2023, listing as first inventor James Fournier, titled “Internet Data Usage Control System;” and U.S. Pat. Pub. No. 2022/0337424 A1, published Oct. 20, 2022, listing as first inventor James Fournier, titled “Apparatuses and Methods for Facilitating Cryptographically Mediated Organizations and Tokens and Related Interactions.”

In implementations, “JLINC protocol” as used herein has the meaning provided in Appendix F.

In implementations, “JLINC contract(s)” as used herein refers to human and machine-readable agreements expressed in JSON and signed with cryptographic keys using standard PKI. This allows human readable agreements, that dictate how data can be used or shared, to be handled automatically and transparently. The expected outcome of the agreement remains apparent to anyone, including a human judge. The parties of the agreement are identified using DIDs and their signatures are executed with standard cryptographic keys using standard PKI.

For convenience, a list of elements depicted in the drawings is provided below:
Computing device 100
Processor 110
Memory 112
Software 114
Various additional components 116
Data and contract system 200
Computing device 202
Interface 204
database server 206
database 208
telecommunications network 210
web server 212
one or more application servers 213
third party servers 214
personal computer 216
display 218
speaker 220
mobile phone 222
display 228
microphone/speaker elements 234
mobile phone 224
display 230
microphone/speaker elements 236
mobile phone 226
display 232
microphone/speaker elements 238
smart glasses 240
display 242
microphone/speaker elements 244
mobile tablet 246
display 248
microphone/speaker elements 250
smart watch 252
display 254
microphone/speaker elements 256
smart speaker 258
robot 260
other human interaction device 262

In places where the phrase “one of A and B” is used herein, including in the claims, wherein A and B are elements, the phrase shall have the meaning “A and/or B.” This shall be extrapolated to as many elements as are recited in this manner, for example the phrase “one of A, B, and C” shall mean “A, B, and/or C,” and so forth. To further clarify, the phrase “one of A, B, and C” would include implementations having: A only; B only; C only; A and B but not C; A and C but not B; B and C but not A; and A and B and C.

In places where the description above refers to specific implementations of test case, one or more or many modifications may be made without departing from the spirit and scope thereof. Details of any specific implementation/embodiment described herein may, wherever possible, be applied to any other specific implementation/embodiment described herein. The appended claims are to encompass within their scope all such changes and modifications as are within the true spirit and scope of this disclosure.

Furthermore, in the claims, if a specific number of an element is intended, such will be explicitly recited, and in the absence of such explicit recitation no such limitation exists. For example, the claims may include phrases such as “at least one” and “one or more” to introduce claim elements. The use of such phrases should not be construed to imply that the introduction of any other claim element by the indefinite article “a” or “an” limits that claim to only one such element, and the same holds true for the use in the claims of definite articles.

Additionally, in places where a claim below uses the term “first” as applied to an element, this does not imply that the claim requires a second (or more) of that element—if the claim does not explicitly recite a “second” of that element, the claim does not require a “second” of that element. Furthermore, in some cases a claim may recite a “second” or “third” or “fourth” (or so on) of an element, and this does not necessarily imply that the claim requires a first (or so on) of that element—if the claim does not explicitly recite a “first” (or so on) of that element (or an element with the same name, such as “a widget” and “a second widget”), then the claim does not require a “first” (or so on) of that element.

As used herein, the term “of” may refer to “coupled with.” For example, in some cases a display may be referred to as a display “of” a first computer or computing device, a display “of” a second computer or computing device, and so forth. These terms are meant to be interpreted broadly so that a display “of” a computing device may be a separate display that is, either by wired or a wireless connection, communicatively coupled with the computing device.

The phrase “computing device” as used herein is meant to include any type of device having one or more processors and capable of communicating information using one or more integrated or communicatively-coupled displays, such as a personal computer, a laptop, a tablet, a mobile phone, a smart phone, a personal data assistant (PDA), smart glasses, a tablet, a smart watch, a smart speaker, a robot, any other human interaction device, and so forth.

It is pointed out that the provider of a software application, to be installed on end user computing devices (such as, by non-limiting example, mobile devices) at least partially facilitates an at least intermittent communicative coupling between one or more servers (which host or otherwise facilitate features of the software application) and the end user computing devices. This is so even if the one or more servers are owned and/or operated by a party other than the provider of the software application.

Method steps disclosed anywhere herein, including in the claims, may be performed in any feasible/possible order. Recitation of method steps in any given order in the claims or elsewhere does not imply that the steps must be performed in that order—such claims and descriptions are intended to cover the steps performed in any order except any orders which are technically impossible or not feasible. However, in some implementations method steps may be performed in the order(s) in which the steps are presented herein, including any order(s) presented in the claims.

What is claimed is:

1. Data contract methods using micro-ledgers, comprising:
using one or more computer processors:
recording to one or more micro-ledgers, using a first software agent having one or more permissions to act on behalf of a first party, one or more events, wherein the one or more permissions of the first software agent include permission to sign a contract on behalf of the first party;
recording to the one or more micro-ledgers, using a second software agent granted one or more permissions to act on behalf of a second party, one or more events, wherein the one or more permissions of the second software agent include permission to sign the contract on behalf of the second party;
wherein the one or more events recorded using the first software agent and the one or more events recorded using the second software agent one of comprise and evidence the contract between the first party and the second party;
wherein the contract is human readable, machine readable, and legally enforceable.

2. A data contract method using micro-ledgers, comprising:
using one or more computer processors:
in response to receiving input from a first party through one or more computing devices, configuring a first software agent with one or more revocable permissions to act on behalf of the first party, the one or more revocable permissions including signing a contract between the first party and a second party;
in response to receiving input from the second party through the one or more computing devices, configuring a second software agent with one or more revocable permissions to act on behalf of the second party, the one or more revocable permissions including signing the contract; and
recording one or more events using the first software agent and the second software agent, each acting within its one or more revocable permissions, to one or more micro-ledgers;
wherein the one or more events one of comprise and evidence the contract; and
wherein the contract is human readable, machine readable, and legally enforceable.

3. The method of claim 2, wherein the input from the first party comprises a cryptographically signed document, and wherein the input from the second party comprises a cryptographically signed document.

4. The method of claim 2, further comprising, in response to receiving input from the first party through the one or more computing devices, revoking one or more or all permissions of the first software agent to act on behalf of the first party.

5. The method of claim 4, further comprising configuring a third software agent with one or more revocable permissions to act on behalf of the first party.

6. The method of claim 2, wherein the method does not require the use of blockchain consensus because formation of the contract, data exchange, and data control occur off-chain, and wherein the method further does not require a consensus fee, does not require the use of a data exchange fee, and does not require the use of a crypto wallet.

7. The method of claim 2, wherein the methods are implemented at least in part using a data-exchange control layer for decentralized applications (dApps).

8. The method of claim 2, wherein the methods are configured to operate outside of a Web3 computing environment.

9. The method of claim 2, wherein the first software agent and the second software agent write to the one or more micro-ledgers using their own unique decentralized identifiers (DIDs), and wherein the DIDs are used to define ownership and access control over the one or more micro-ledgers.

10. The method of claim 9, wherein one or more DID documents are further used to define ownership and access control over the one or more micro-ledgers.

11. The method of claim 2, wherein the one or more micro-ledgers do not require any token, do not require centralization, and do not require authority to be created or shared.

12. A data contract system using micro-ledgers, comprising:
one or more servers at least intermittently communicatively coupled with one or more computing devices and providing one or more software elements, the one or more software elements configured to be executed by one or more processors to;
in response to receiving input from a first party through the one or more computing devices, configure a first software agent with one or more revocable permissions to act on behalf of the first party, the one or more revocable permissions including signing a contract between the first party and a second party;
in response to receiving input from the second party through the one or more computing devices, configure a second software agent with one or more revocable permissions to act on behalf of the second party, the one or more revocable permissions including signing the contract;
record one or more events using the first software agent and the second software agent, each acting within its one or more revocable permissions, to one or more micro-ledgers; and
wherein the one or more events one of comprise and evidence the contract; and
wherein the contract is human readable, machine readable, and legally enforceable.

13. The system of claim 12, wherein the first software agent and the second software agent write to the one or more micro-ledgers using their own unique decentralized identifiers (DIDs).

14. The system of claim 12, wherein the one or more events are recorded using a directed acyclic graph (DAG) data structure.

15. The system of claim 14, wherein the one or more software elements are configured to record the one or more events regardless of which specific DAG data structure is used.

16. The system of claim 12, wherein the contract facilitates an automated data exchange between data stores and governs use of the exchanged data.

17. The system of claim 12, wherein one of the first software agent and the second software agent comprises software code running in a cloud computing environment.

18. The system of claim 12, wherein one of the first software agent and the second software agent is substantially always online in a networked computing environment.

19. The system of claim 12, wherein the one or more events recorded by the first software agent and the one or more events recorded by the second software agent are immutable, non-repudiable, and auditable.

20. The system of claim 12, wherein the one or more software elements are further configured to write to one or more documents using the first software agent or the second software agent, and wherein the one or more documents one of comprise and evidence the contract.
